(19) United States
(12) Patent Application Publication
(10) Pub. No.: US 2017/0346896 A1
(43) Pub. Date: Nov. 30, 2017

(54) SYNCHRONIZED CONTENT DISPLAY ACROSS A PLURALITY OF DEVICES

(71) Applicant: ADOBE SYSTEMS INCORPORATED, SAN JOSE, CA (US)

(72) Inventors: Mike Harris, Santa Rose, CA (US); Mark Rausch, San Francisco, CA (US); Duane O'Brien, Oakland, CA (US); Charles C. Scheinost, Forest Knolls, CA (US); Amit Kishnani, Foster City, CA (US); Bruce Bowman, San Jose, CA (US); Matthew Hamlin, San Francisco, CA (US); Tom Juhasz, Bainbridge Island, WA (US); Matthew Johnson, Delano, MN (US); Christian Cantrell, Sterling, VA (US)

(21) Appl. No.: 15/662,592

(22) Filed: Jul. 28, 2017

Related U.S. Application Data
(63) Continuation of application No. 13/397,361, filed on Feb. 15, 2012, now abandoned.

(51) Int. Cl. H04L 29/08; H04W 4/20

(52) U.S. Cl. CPC H04L 67/1095; H04L 67/02; H04W 4/20

(57) ABSTRACT

An apparatus and method for synchronized content display across a plurality of devices are disclosed herein. Content specified at a first device is deployed to the rest of the plurality of devices that are of diverse device types to each other. The first device instructs the other devices to render the content at each of the respective devices according to the respective device's content viewer and configuration. The first device also instructs the other devices to achieve a certain setting or state pertaining to true rendering of the content depending on the type of content to be rendered.

### CROSS REFERENCE TO RELATED APPLICATIONS

This application is a continuation application of U.S. application Ser. No. 13/397,361 (filed Feb. 15, 2012), which is hereby incorporated by reference in its entirety.

### FIELD

The present disclosure relates generally to content synchronization. More particularly, the present disclosure relates to synchronization of content display across a plurality of devices.

### BACKGROUND

As electronic content consumption increases each year, the number and types of devices on which content can be consumed is also proliferating. There is a wide variety in the size, shape, operating systems, and/or content viewing applications of such devices. And the variety is ever increasing as new categories of devices are created capable of rendering and presenting content to users.

With the proliferation of different types of devices, a user may own and/or interact with more than one device. The user may desire to have the same content on more than one of his/her devices. Content may be provided across a plurality of devices by a server. However, managing synchronization of content display across devices without using a server is more difficult.

Another downside of rendering content on different types of devices is the tendency for the same content to render differently or unexpectedly across devices types. For this reason, content development includes testing created content on different device types and making iterative adjustments to the content, as appropriate, until the same content renders as the developer intends across a variety of device types. No matter the type of content being tested, it typically takes multiple keystrokes or user interface screens on a given device to access and render created content. Thus, manual interaction with multiple devices to test rendering of content is a tedious process.

### BRIEF DESCRIPTION OF THE DRAWINGS

Some embodiments are illustrated by way of example and not limitations in the figures of the accompanying drawings, in which:

FIG. 1 illustrates an example system for synchronizing content display on a plurality of devices from a central control unit according to some embodiments.

FIGS. 2A-2C illustrates an example flow diagram for implementing synchronized content display on the plurality of devices from a central control unit of FIG. 1 according to some embodiments.

FIG. 3 illustrates example modules used to implement the functionalities provided in the flow diagram of FIGS. 2A-2C according to some embodiments.

FIG. 4 shows a diagrammatic representation of a machine in the example form of a computer system within which a set of instructions, for causing the machine to perform any one or more of the methodologies of FIGS. 2A-2C and 3 according to some embodiments.

The headings provided herein are for convenience only and do not necessarily affect the scope or meaning of the terms used.

### DETAILED DESCRIPTION

The following description is presented to enable any person skilled in the art to create and use a computer system configuration and related method and article of manufacture to display content specified at a first device to each of a plurality of diverse device types. In some embodiments, the first device transmits content to be rendered at the other devices along with one or more commands associated with rendering of the content. The command may comprise an instruction for each of the devices to render the content using a content viewer as appropriate for each particular device. The command may also comprise an instruction for the devices to achieve a certain device setting or state pertaining to true rendering of the content (e.g., clear cache and cookie, screen orientation) depending on the type of content to be rendered.

Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that embodiments of the invention may be practiced without the use of these specific details. In other instances, well-known structures and processes are not shown in block diagram form in order not to obscure the description of the invention with unnecessary detail. Thus, the present disclosure is not intended to be limited to the embodiments shown, but is to be accorded the widest scope consistent with the principles and features disclosed herein.

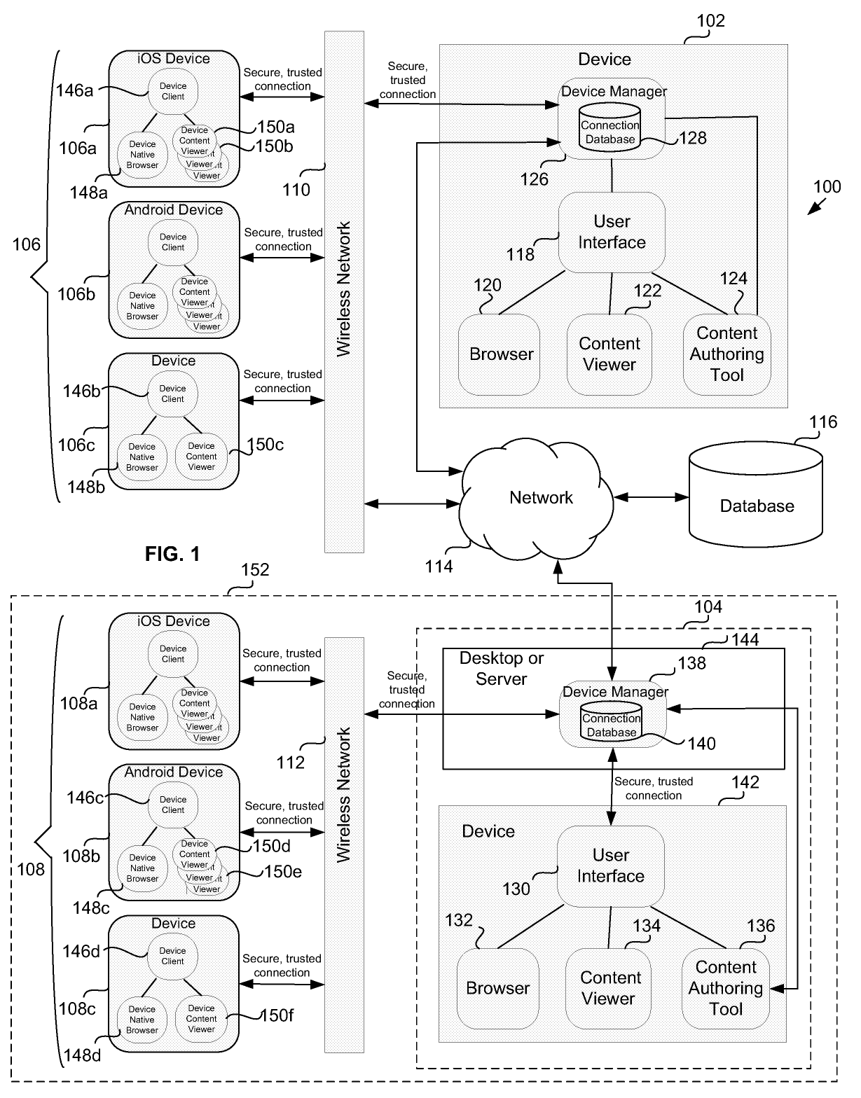

FIG. 1 illustrates an example system 100 for synchronizing content display on a plurality of devices according to some embodiments. System 100 includes a first control unit 102, a second control unit 104, a plurality of devices 106a, 106b, 106c (collectively referred to as devices 106 and any one of the devices 106a, b, c as a device 106), a plurality of devices 108a, 108b, 108c (collectively referred to as device 108 and any one of the devices 108a, b, c as a device 108), a first network 110, a second network 112, a network 114, and a database 116. Each of the first control unit 102, second control unit 104, first network 110, and database 116 is in communication with the network 114.

The first control unit 102 comprises a computing device—such as, but not limited to, a computer (e.g., laptop, desktop, workstation), server, or mobile communication device including one or more processors configured to communicate with devices 106 via first network 110. The first control unit 102 is also configured to communicate with each of the second control unit 104 and the database 116 via network 114. The first control unit 102 includes one or more applications, developed content, and information about devices 106 to initiate the synchronization function. In one embodiment, the first control unit 102 includes a user interface 118, a browser 120 (e.g., web browser application such as INTERNET EXPLORER, FIREFOX, SAFARI, etc.), a content viewer 122, a content authoring tool 124, a device manager 126, and a (connection) database 128. The user interface 118 is configured for communication with each of the browser 120, content viewer 122, content authoring tool 124, and device manager 126. The content authoring tool 124 communicates with the device manager 126. The database 128 is shown in FIG. 1 as being part of the device manager 126. Alternatively, the database 128 may be provided outside of the device manager 126 while still configured for communication with the device manager 126. The first control unit 102 may be referred to as a device, computing device, a first device, or a central control unit, an initiation unit, or a push unit.

To be described in detail below, a user (e.g., content developer or tester) interacts with the user interface 118 to control the first control unit 102. For instance, the user creates or updates content using the user interface 118, which in turn interfaces with the content authoring tool 124. As another example, the user may access content using the user interface 118 for rendering on the browser 120 or content viewer 122 (e.g., Adobe® Photoshop®). The user similarly interacts with the user interface 118 to instruct the device manager 126 to perform synchronization or pushing of content to other devices, such as devices 106. The database 128 includes device information, network information, and the like to facilitate the synchronization or pushing of content to other devices.

The second control unit 104 is similar to the first control unit 102 except that it comprises two machines instead of one. The second control unit 104 includes a user interface 130, a browser 132, a content viewer 134, a content authoring tool 136, a device manager 138, and a (connection) database 140, which are similar, respectively, to the user interface 118, browser 120, content viewer 122, content authoring tool 124, device manager 126, and database 128 of the first control unit 102. The user interface 130, browser 132, content viewer 134, and content authoring tool 136 are provided in a computing device 142, while the device manager 138 and database 140 are provided in a separate computer (e.g., laptop, desktop, workstation) or server 144. Computing device 142 and computer/server 144 communicate with each other over a secure, trusted connection (which may be either a wired or wireless network). The implementation of each of the first and second control units 102,104 using one, two, or more machines is merely one of design choice. However many machines are used in the implementation, similar functionalities are provided by each of the first and second control units 102, 104. The second control unit 104 may be referred to as a device, computing device, a first device, a central control unit, an initiation unit, or a push unit.

The first and second control units 102, 104 can be geographically co-located or distributed from each other. For example, the first control unit 102 may be located in the United States and the second control unit 104 may be located in China. The first and second control units 102, 104 communicate with each other via the network 114, and each may access information stored in the database 116.

Each of the devices 106 comprises a computer or other computing device, including but not limited to, work stations, personal computers, general purpose computers, Internet appliances, Internet-enabled televisions, Internet-enabled entertainment systems, hand-held devices, wireless devices, portable devices, wearable computers, cellular or mobile phones, portable digital assistants (PDAs), smart phones, tablets, multi-processor systems, microprocessor-based or programmable consumer electronics, game consoles, set-top boxes, network PCs, mini-computers, and the like. The devices 106 comprise a variety of different types of devices—different from each other in hardware, firmware, software, operating system, platform, web browser, content viewing applications, and/or the like. As shown in FIG. 1, for example, device 106a can be a device running a particular version of the iOS operating system, device 106b can be a device running a particular version of the Android operating system, while device 106c can be an Internet-enabled television. Although three devices 106 are shown in FIG. 1, it is understood that more or less than three devices may be included in the system 100. As an example, 100 different types of devices may be represented by the devices 106.

Each of the devices 106 communicates with the first control unit 102 via the first network 110. Devices 106 may be geographically distributed or co-located with each other. One or more of devices 106 may be geographically co-located or dispersed from the first control unit 102. Device 106a includes a device client 146a, a device native browser 148a (e.g., web browser application such as INTERNET EXPLORER, FIREFOX, SAFARI, etc.), and one or more device content viewers 150a, 150b. Device 106b includes a device client, a device native browser (e.g., web browser application such as INTERNET EXPLORER, FIREFOX, SAFARI, etc.), and one or more device content viewers. Device 106c includes a device client 146b, a device native browser 148b (e.g., web browser application such as INTERNET EXPLORER, FIREFOX, SAFARI, etc.), and one or more device content viewers 150c. Device clients 146a, b, etc. included in the devices 106a, b, c are collectively referred to as device clients 146, and any one of the device clients 146a, b, etc. is referred to as a device client 146. Device native browsers 148a, b, etc. included in the devices 106a, b, c are collectively referred to as device native browsers 148, and any one of the device native browsers 148a, b, etc. is referred to as a device native browser 148. Device content viewers 150a, b, c included in the devices 106a, b, c are collectively referred to as device content viewers 150, and any one of the device content viewers 150a, b, c is referred to as a device content viewer 150. A device client 146 is installed on each of the devices 106 to facilitate communication with the first control unit 102. The device native browser 148 may differ from one type of device to another. For example, Safari may be the native browser for an iOS device (e.g., device 106a) while Chrome may be the native browser for an Android device (e.g., device 106b). Similarly, the content viewer 150 may differ from one type of device to another.

The devices 108 are similar to the devices 106 except that devices 108 are configured to communicate with the second control unit 104 over the second network 112.

Each of the first and second control units 102, 104 can be computing devices similar to devices 106, 108. The first control unit 102 differs from devices 106, 108 by inclusion of the device manager 126 and connection database 128 instead of the device clients 146a, b, c, d in devices 106, 108. The second control unit 104 differs from devices 106, 108 by inclusion of the device manager 138 and connection database 140 instead of the device clients 146a, b, c, d in devices 106, 108. Accordingly, as an example, the first control unit 102 and the devices 106 together comprise a plurality of devices, with the first control unit 102 being a device from among the plurality of devices that establishes communication with the rest of the plurality of devices to effect content synchronization among the plurality of devices. As another example, the second control unit 104 and the devices 108 can comprise a plurality of devices for content synchronization. As still another example, the first control unit 102 and the devices 108 can comprise a plurality of devices for content synchronization.

Each of the first network 110 and second network 112 comprises a communications network, such as a local area network (LAN), a wireless LAN (WLAN), a wide area network (WAN), a wireless WAN (WWAN), a metropolitan area network (MAN), an ad hoc network, an intranet, an extranet, a virtual private network (VPN), a WiFi network, a WiMax network, a portion of the Internet, the Internet, a portion of a public switched telephone network (PSTN), a cellular network, or a combination of two or more such networks. When first or second network 110, 112 comprises a public network, security features (e.g., VPN/SSL secure transport) may be included to ensure authorized access on the network. Each of the first and second networks 110, 112 comprises a wired or wireless network. The devices 106 and/or 108 communicate with the appropriate control unit using, for example, Transmission Control Protocol/Internet Protocol (TCP/IP).

In one embodiment, the first and second networks 110, 112 comprise different types of networks that are incompatible with each other. For example, the first network 110 may be a Global System for Mobile Communications (GSM) cellular network and the second network 112 may be a Code Division Multiple Access (CDMA) cellular network. In this case, the devices 106 (which are GSM chip devices) cannot communicate over the second network 112. Conversely, the devices 108 (which are CDMA chip devices) cannot communicate over the first network 110. In another embodiment, the first and second networks 110, 112 may comprise geographically distant networks from each other, such that the devices 106 on the first network 110 are out of range of communication with the second network 112, and the devices 108 on the second network 112 are out of range of communication with the first network 110.

Hence, in some embodiments, the first control unit 102 and the devices 106 comprise a wireless peer-to-peer network with the first network 110. Similarly, the second control unit 104 and the devices 108 comprise a wireless peer-to-peer network with the second network 112.

The network 114 comprises a communications network, such as a local area network (LAN), a wireless LAN (WLAN), a wide area network (WAN), a wireless WAN (WWAN), a metropolitan area network (MAN), an ad hoc network, an intranet, an extranet, a virtual private network (VPN), a portion of the Internet, the Internet, a portion of a public switched telephone network (PSTN), a cellular network, or a combination of two or more such networks. When network 114 comprises a public network, security features (e.g., VPN/SSL secure transport) may be included to ensure authorized access within system 100.

Database 116 comprises one or more databases configured to communicate with the first control unit 102 and/or the second control unit 104. Database 116 may be located at one or more geographically distributed locations from each other and also from first or second control units 102, 104. Alternatively, database 116 may be included within the first or second control unit 102, 104. Database 116 comprises a storage device for storing data for use by the first or second control unit 102, 104. For example, the database 116 may store information about devices (e.g., device model number, its operating system version, firmware version, carrier information, IP address, connection history, device parameter settings, etc.), secure connection information (e.g., security tokens), developed content, and the like.

In one embodiment, the device manager 126 of the first control unit 102 is configured to provide content and/or commands to the devices 106 over the first network 110. The device manager 126 is responding to instructions issued by the user on the user interface 118. In another embodiment, the user interacts with the user interface 130 and device manager 138 of the second control unit 104 to cause the device manager 126 of the first control unit 102 (via network 114) to communicate with the devices 106 over the first network 110. The database 116 can serve as a linking mechanism by providing device and secure connection information unknown by the second control unit 104 to the first control unit 102. Such indirect control over the devices 106 may arise when, for example, a subsystem 152 (including the second control unit 104, devices 108, and second network 112) is geographically distal to the devices 106 and/or because the second control unit 104 is on a different network from the first network 110 and is unable to directly communicate with the devices 106. For example, a developer in China may wish to test content developed in China on devices located in the United States. The first and second control units 102, 104 enjoy a trusted server-to-server type of relationship, which provides a synchronization environment across separate, disparate networks.

Accordingly, although not shown in FIG. 1, a control unit can be included in the system 100 that does not have direct communication capabilities with devices. For example, devices 106 and first network 110 may be omitted, and a user can interact with the devices 108 from the first control unit 102 or the second control unit 104.

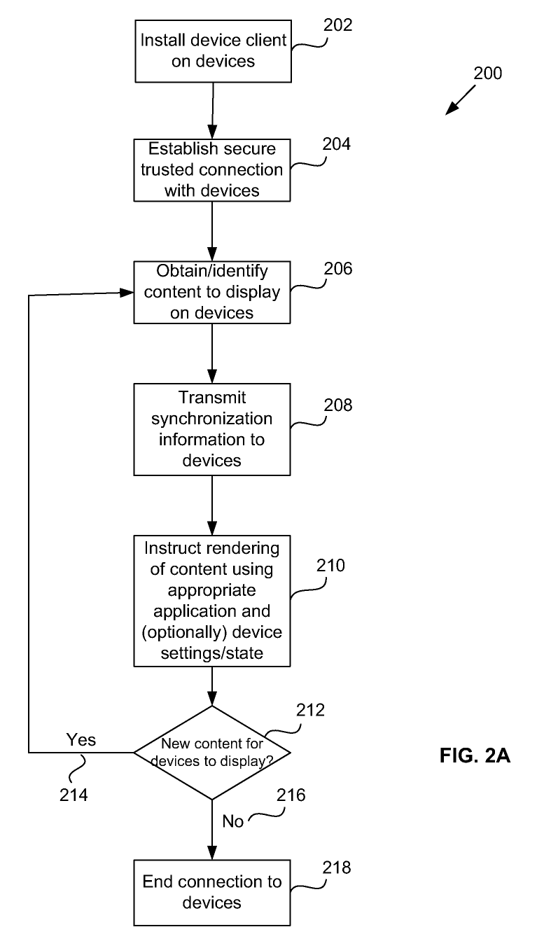

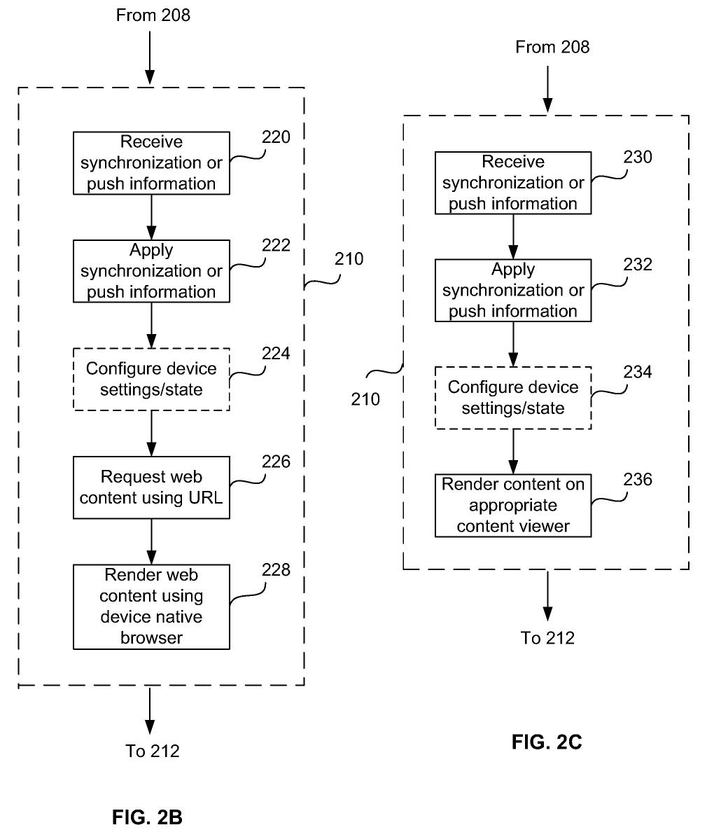

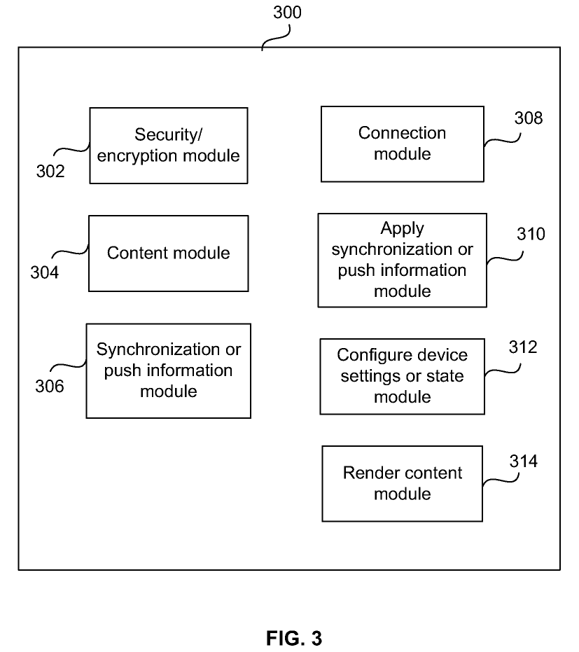

FIG. 2A illustrates an example flow diagram 200 for providing synchronized content display on a plurality of devices from a central control location according to some embodiments. FIG. 3 illustrates example modules 300 included in the device manager 126, device manager 138, and/or device client 146 to implement the functionalities in accordance with the flow diagram 200. FIG. 2A will be discussed in conjunction with FIG. 3. Flow diagram 200 and modules 300 are discussed below with respect to the first control unit 102, devices 106, and first network 110. However, it is understood that the discussion also applies to the second control unit 104, devices 108, and second network 112, respectively.

At a block 202, the device client 146 is installed on each of the devices 106. In one embodiment, the device client 106 can be provided by the first control unit 102 via the first network 110. In another embodiment, the device client 146 can comprise an app that is accessible (and downloadable) from an appropriate e-commerce site associated with the brand of the device 106. For example, for an Android-type of device, the device client 106 may be installed from an Android Market Place e-commerce site, whereas an iOS-type device may obtain its device client 106 from iTunes.

The efficient synchronizing or pushing of content discussed herein is facilitated by one or more components hosted at each of the first control unit 102, second control unit 104, devices 106, and devices 108. In particular, each of the device manager 126 in the first control unit 102 and the device manager 138 in the second control unit 104 comprises one or more software components, modules, applications, or other units of code base or instructions configured to be executed by one or more processors included in the first and second control units 102, 104, respectively, to establish a secure, trusted connection with the devices and to provide command to the devices. The device client 146 in each of the devices 106, 108 comprises one or more software components, modules, applications, or other units of code base or instructions configured to be executed by one or more processors included in the devices, 106, 108 to also establish a secure, trusted connection with the first or second control unit 102, 104, respectively, and to correctly interpret commands from the first or second control unit 102, 104. In response, the devices 106 render content just as it would if the user picked up each of the devices 106 and navigated (or otherwise manually interfaced with the devices 106) to the content directly on the devices 106.

At a block 204, a security/encryption module 302 is configured to establish a secure, trusted connection between the first control unit 102 and each of the devices 106 over the first network 110. The security/encryption module 302 may be included in each of the device manager 126 and device client 146. A trusted connection is secured between the first control unit 102 and each of the devices 106 by exchanging a set of security keys (also referred to as security code or tokens) indicating that a given pair of machines is allowed to communicate with each other. In a given pair of machines, the first control unit 102 and the device 106 independently obtains information about its environment, machine state, etc. to determine what a successful security key should be. This code or token is exchanged between the first control unit 102 and the device 106. A secure, trusted connection may persistent for an entire session. For the initial connection, the user may manually enter a network address, IP addresses, etc. to specify connection parameters.

Once a secure connection has been established with all of the desired devices 106 (connection to less than all of the devices 106 may or can be established), the user (e.g., content developer) specifies what content should be rendered on the connected devices 106 via interaction with the user interface 118 (or user interface 130) (block 206). A content module 304 is included in the user interface 118 (and user interface 130) or device manager 126 (and device manager 138), and which is configured to accept, retrieve, and/or otherwise ready the user identified content for use by the device manager 126.

In one embodiment, the content specified by the user comprises a URL. The URL corresponds to web content (e.g., web page, web site, etc.) hosted on a specific web server (public facing or behind a firewall) or on the first control unit 102 itself with a WAMP/MAMP stack. The web content may have been previously developed using the content authoring tool 124 (e.g., Adobe® Photoshop®, INDESIGN, FIREWORKS, etc.). The user navigates to the web content using the user interface 118 and the browser 120. In another embodiment, the content comprises images, video, print media, web pages, web site, visual asset, etc. (collectively referred to as “visual content”) authored using the content authoring tool 124 or elsewhere and loaded on the first control unit 102. The content can be stored in the database 128. Alternatively, the content may be stored in the database 116 and retrieved via the network 114. The user selects the visual content via the user interface 118.

Next, a synchronization or push information module 306 included in the device manager 126 is configured to generate synchronization or push information for transmission to the connected devices 106 (block 208). The synchronization or push information comprises the user identified content (e.g., URL or visual content), one or more commands instructing each of the connected devices 106 to render the content at its display, and (optionally) one or more commands instructing the connected devices 106 to configure certain parameters or to achieve a certain state for true rendering of the content. The command(s) includes, but is not limited to, a security token, connection parameters, an array of device identifiers (corresponding to the connected devices 106), instruction to render content, instruction to clear the cache and/or cookies, instruction for screen orientation, or commands to interrogate or set the state of the device 106, device native browser 148, and/or device content viewer 150 (such as setting the device 106 to vibrate or provide console outputs to a log file), and the like. The user may specify certain instructions (e.g., clear cache or cookies, screen orientation) using the user interface 118, or the device manager 126 may automatically include such instructions in the command portion of the synchronization or push information.

The synchronization or push information is also encrypted to protect against unauthorized interception of communication between the first control unit 102 and the devices 106 by third parties. A communication module 308 included in the device manager 126 is configured to broadcast or unicast the synchronization or push information to each of the devices 106 over the first network 110. The transmission of the synchronization or push information to the devices 106 is also referred to as pushing, delivering, or providing content and rendering command(s) from a central control unit to a plurality of devices 106.

In one embodiment, in which the content comprises a URL, the same synchronization or push information can be transmitted to all of the devices 106. In response, the device client 146 at each of the devices 106 is configured to interpret or extract the data pertinent to the particular device to carry out the command(s). In another embodiment, in which the content comprises visual content, the content portion of the synchronization or push information is tailored for the device type. Based on the dimensions of the visual content, the display size and resolution of a particular device, a version of the visual content appropriate for the particular device is pushed to that device (by the device manager 126). The first control unit 102 includes device information and potentially different versions of the visual content, such as a first version of a visual content sized for the iphone 3, a second version of the same visual content sized for the iphone 4S, a third version of the same visual content sized for the ipad 2, a fourth version of the same visual content sized for the Kindle Fire, a fifth version of the same visual content sized for the Blackberry Playbook, etc. In another embodiment, a single version of a given visual content can be included in the first control unit 102, wherein the visual content includes instructions for how it is to be rendered on different device types. The device content viewer 150 or device native browser 148 acts on those instructions to render the visual content specific to the particular device 106.

The command instructing the devices 106 to achieve certain device settings or state (e.g., clear cache and cookies, a particular screen orientation) to facilitate true rendering of the content can be a separate command or be in a separate transmission from the command instructing the devices 106 to render content. Content displayed on each of the devices 106 may be considered to be a true rendering of such content based on its fidelity in comparison to a reference display of such content (e.g., as displayed on the first control unit 102). If, for example, the rendered content at a given device 106 is different from the reference display of the content above a pre-determined threshold or criteria, then it is not considered to be a true rendering. For instance, if content is set to render in landscape mode but it renders in portrait mode on the device 106, then such content may be considered to be not truly rendered.

In one embodiment, the command associated with the device settings or state is provided depending on the type of content to be rendered. For instance, in the case of content comprising a URL, when the devices' cache and cookies are cleared, the user is ensured that the web content rendering on the devices 106 is the same version of the web content currently requested to be rendered. Otherwise, different versions of the web content corresponding to the URL that was previously rendered on the devices 106 may be saved in the devices' cache and cookies, and the devices 106 may access a locally saved older version of the web content rather than requesting the latest version from the source specified by the URL. In another embodiment, the command for the device settings or state may be sent less frequently than commands to render content. For example, the command may be provided periodically.

When the transmitted synchronization or push information is received by the device client 146 at each of the devices 106, such information instructs each of the devices 106 to display or render the content using an appropriate application (block 210). Such information may also instruct each of the devices 106 to clear its cache and cookies, specify screen orientation (e.g., landscape or portrait), or specify other device settings/state to facilitate true or accurate content rendering by the devices 106.

The device client 146 installed on each of the devices 106 is configured to cause its respective device 106 to render the specified content using an appropriate application provided in the particular device. Each of the devices 106 determines what application is appropriate for rendering the content on its system. Each of the devices 106 also determines how the content should be rendered; the first control unit 102 does not control this. The synchronization or push information specifies the content to be rendered and requests all of the devices 106 to render the content as it normally would, just as if the user accessed that content directly on a given device 106 via manual manipulation of the given device 106. The command pertaining to the device settings or state similarly comprises one or more instructions requesting the devices 106 to achieve a certain device setting or state. The first control unit 102 does not instruct the devices 106 how to achieve the requested device setting or state; each of the devices 106 determines what actions are required (which may be unique for each type of devices) to achieve the request. As an example, the devices 106 are commanded to set screen orientation to landscape. In response, each of the devices 106 determines what actions or setting changes are required to achieve a landscape screen orientation. Once screen orientation is set by the devices 106, each of the devices 106 displays content in landscape mode.

FIG. 2B illustrates example sub-blocks relating to the instruct block 210 of FIG. 2A according to some embodiments. At a block 220, the device client 146 at each of the devices 106 receives the synchronization or push information over the first network 110. An apply synchronization or push information module 310 (FIG. 3) included in the device client 146 processes or interprets the synchronization or push information applicable for the particular device 106 (block 222). Since the same synchronization or push information is received by all of the devices 106 but the devices 106 can be different from each other in model number, operating system version, firmware version, etc., the apply synchronization or push information module 310 on a particular device 106 is configured to extract/interpret the information pertinent for that device 106.

If the synchronization or push information includes an instruction pertaining to the device settings or state, a configured device setting and state module 312 included in the device client 146 causes the device 106 to configure its settings or state accordingly (block 224). As discussed above, the first control unit 102 can instruct the devices 106 to clean its cache and cookies, go into a certain screen orientation (landscape or portrait), and the like.

Next at a block 226, a render content module 314 included in the device client 146 is configured to launch the device's native web browser 148 and provide the received URL to the browser 148. The device native browser 148 retrieves the web content corresponding to the URL and renders it on the display of the device 106 (block 228). For example, if the device 106 is an iOS device, its native web browser may be Safari. As another example, if the device 106 is an Android device, its native web browser may be Chrome. The functionalities performed by blocks 224-226 are the same as when a user directly inputs commands or interacts with the given device 106.

Blocks 220-228 are performed at each of the devices 106 in response to receipt of the synchronization or push information. Accordingly, synchronized (web) browsing is achieved across the first control unit 102 and all of the devices 106. The user may view each of the devices 106 to assess how the content renders on different devices.

Thus, FIG. 2B illustrates a “follow me” mode. As the user navigates to a URL on the first control unit 102, the device manager 126 automatically sends synchronization or push information to the devices 106 so that those devices also navigate to the same URL. When the user navigates to a new URL on the first control unit 102 (e.g., enters a URL or follows a link included in a URL), the device manager 126 sends a new synchronization or push information to the devices 106, which again causes the devices 106 to navigate to the new URL. In this manner, the same web content synchronously displays on a plurality of devices.

FIG. 2C illustrates alternative example sub-blocks relating to the instruct block 210 of FIG. 2A according to some embodiments. At a block 230, the device client 146 at each of the devices 106 receives the synchronization or push information over the first network 110. The apply synchronization or push information module 310 included in the device client 146 processes or interprets the synchronization or push information applicable for the particular device 106 (block 232). Since at least the same command (e.g., request to render content) included in the synchronization or push information is received by all of the devices 106 but the devices 106 are different from each other in model number, operating system version, firmware version, etc., the apply synchronization or push information module 310 on a particular device 106 is configured to extract the information pertinent for that device 106.

If the synchronization or push information includes an instruction pertaining to the device settings or state, the configured device setting and state module 312 included in the device client 146 causes the device 106 to configure its settings or state accordingly (block 234). As discussed above, the first control unit 102 can instruct the devices 106 to clean its cache and cookies, go into a certain screen orientation (landscape or portrait), and/or the like.

Next at a block 236, the render content module 314 included in the device client 146 is configured to launch the appropriate device content viewer 150 on the device 106 and provide the received content to be rendered by the selected device content viewer 150. The render content module 314 may determine the appropriate device content viewer 150 based on the file extension of the received content. The content is thus displayed on the device 106. The functionalities performed by blocks 234-236 is the same as when a user directly inputs commands or interacts with the given device 106.

Blocks 230-236 are performed at each of the devices 106 in response to receipt of the synchronization or push information. Accordingly, synchronized content display is achieved across the first control unit 102 and all of the devices 106. The user may view each of the devices 106 to assess how the content renders on different devices.

Thus, FIG. 2C illustrates a “design preview” mode according to some embodiments. Content authored on the first control unit 102 (or elsewhere) using the content authoring tool 124 can be transferred from the first control unit 102 to each of the connected devices 106 and displayed on an appropriate device content viewer 150 for each of the devices 106. Such content pushing mechanism facilitates rapid design, deployment, viewing, and revisions, as appropriate, to finalize content creation. Alternatively, FIG. 2C illustrates in general synchronous content display on a plurality of devices. Such synchronization may be useful for a user that owns more than one device and wishes to have content existing on one device also exist on his/her other devices.

If the user directly interacts with any of the devices 106 after block 228 or 236 by, for example, entering a different URL or following a link included in the displayed web content on the device native browser 148 at a given device 106, the device responds to those input commands. The newly requested web content is rendered only on that device (while the other devices 106 and the first control unit 102 continue to display the synchronized web content). When the user completes navigating on the given device 106, the next synchronization or push information transmitted from the first control unit 102 causes the given device 106 (and the other devices 106) to synchronously display the content specified in the next synchronization or push information. Alternatively, the user may request a re-synchronization at the user interface 118, which causes a re-synchronization command to be transmitted to all the devices 106. In response, all of the devices 106 (including the given device 106 which now potentially displays a different URL from the other devices 106) performs at least blocks 226-228 or 236 (if not blocks 220-228 or blocks 230-236, respectively) to re-render or re-display the latest content specified by the synchronization or push information.

Returning to FIG. 2A, when synchronization of content display is complete, the first control unit 102 and the devices 106 awaits the user's next input (block 212). The user can directly and independently interact with the displayed content on one or more of devices 106, e.g., following an active link on the displayed content page. If the user indicates a new synchronization of content display at the user interface 118 (yes branch 214), then the flow diagram 200 returns to the block 206 and the process described above is repeated and all of the devices 106 are brought back into synchronization of display of the intended content. Otherwise (no branch 216), if no further synchronization is required (or synchronization with devices on a different network from the first network 110 is desired), then the connection session with the devices 106 may end (block 218).

Both user-initiated and automatic synchronization are contemplated in embodiments of the present disclosure. For example, the user at the first control unit 102 may explicitly specify a particular content and also command transmission and synchronization of such content to the rest of the plurality of devices. Alternatively, the system 100 may be configured such that whatever content displays on the first control unit 102 is automatically conveyed to the rest of the plurality of devices to achieve synchronized content display among the plurality of devices at any given point in time. In such operation mode, one or more of blocks 204-218 of FIG. 2A may be performed without user input.

In this manner, a mechanism is provided for synchronized display of a variety of content types on a plurality of devices of similar or dissimilar device types. The synchronized content display is achieved using a wireless peer-to-peer network in some embodiments. The mechanism provides ease of delivery of content from a first device (also referred to a control unit) to the rest of the plurality of devices. The content can comprise a URL or visual content. The mechanism also provides for transmission of instructions relating to the content from the first device to the rest of the plurality of devices, the instructions being provided depending on the type of content to be rendered on the rest of the plurality of devices. The instructions configured for the rest of the devices to achieve a certain device setting or state to ensure true rendering of the content.

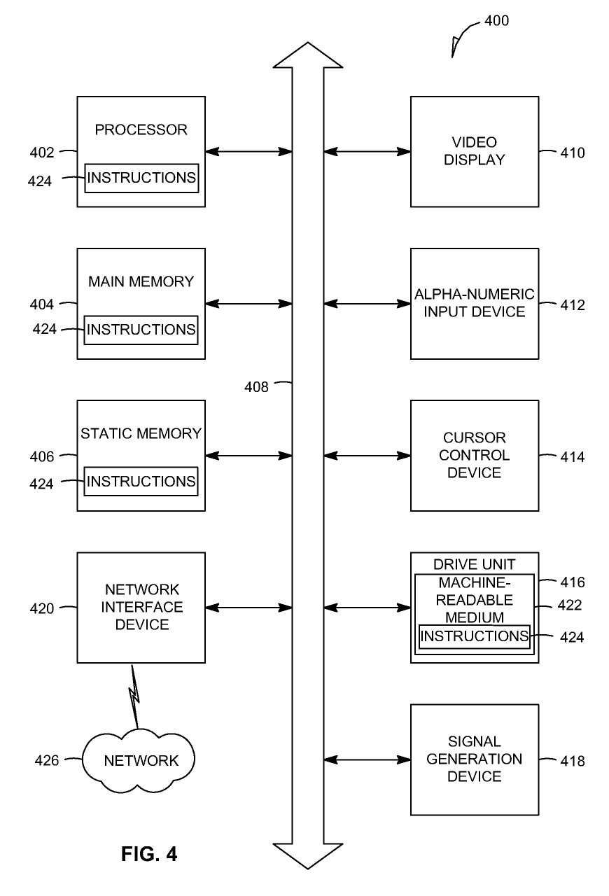

FIG. 4 shows a diagrammatic representation of a machine in the example form of a computer system 400 within which a set of instructions, for causing the machine to perform any one or more of the methodologies discussed herein, may be executed. As an example, the computer system 400 may comprise any of the first control unit 102, second control unit 104, devices 106, and/or devices 108. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., liquid crystal display (LCD), touch screen, or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420.

While the machine-readable medium 422 is shown in an example embodiment to be a single medium, the term “machine-readable medium,” “computer readable medium,” and the like should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the spirit and scope of the invention.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for displaying content, the method comprising:
identifying a content displayed at a first device;
establishing a wireless peer-to-peer direct connection between the first device and a second device without utilizing any server to establish the wireless peer-to-peer direct connection;
identifying, from the second device via the wireless peer-to-peer direct connection, device information of the second device, wherein the device information for the second device includes a display size and a resolution of the second device;
communicating the device information of the second device to the first device via the wireless peer-to-peer direct connection;
based on dimensions of the content and the display size and the resolution of the second device, modifying, at the first device, the content to generate a first version of the content that is customized for the dimensions of the content, and the display size and the resolution identified for the second device; and
transmitting to the second device from the first device, via the wireless peer-to-peer direct connection between the first device and the second device and without utilizing any server, the first version of the content and a command to render the first version of the content at the second device, wherein the command causes the second device to display the first version of content at the second device according to one or more device settings included in the command.

2. The method of claim 1, wherein the one or more device settings includes clearing a cache on the second device.

3. The method of claim 1, wherein the one or more device settings includes clearing cookies on the second device.

4. The method of claim 1, wherein the one or more device settings includes a particular screen orientation.

5. The method of claim 1, wherein the wireless peer-to-peer direct connection comprises a WiFi or cellular network.

6. The method of claim 1, wherein the content comprises at least one of an image, video, print media, web page, web site, visual asset, and visual content.

7. The method of claim 1, further comprising:
establishing a wireless peer-to-peer direct connection between the first device and a third device without utilizing any server to establish the wireless peer-to-peer direct connection;
identifying, from the third device via the wireless peer-to-peer direct connection, device information of the third device, wherein the device information for the third device includes a display size and a resolution of the third device;
communicating the device information of the third device to the first device via the wireless peer-to-peer direct connection;
based on dimensions of the content and the display size and the resolution of the third device, modifying, at the first device, the content to generate a second version of the content that is customized for the dimensions of the content, and the display size and the resolution identified for the third device; and
transmitting to the third device, via the wireless peer-to-peer direct connection between the first device and the third device and without utilizing any server, the second version of the content and a command to render the second version of the content at the third device, wherein the command causes the third device to display the second version of content at the third device according to one or more device settings included in the command.

8. One or more computer-readable media having a plurality of executable instructions embodied thereon, which, when executed by one or more processors, cause the one or more processors to perform a method comprising:
identifying a content displayed at a first device;
establishing a wireless peer-to-peer direct connection between the first device and a second device without utilizing any server to establish the wireless peer-to-peer direct connection;
identifying, from the second device via the wireless peer-to-peer direct connection, device information of the second device, wherein the device information for the second device includes a display size and a resolution of the second device;
communicating the device information of the second device to the first device via the wireless peer-to-peer direct connection;
based on dimensions of the content and the display size and the resolution of the second device, modifying, at the first device, the content to generate a first version of the content that is customized for the dimensions of the content, and the display size and the resolution identified for the second device; and
transmitting to the second device from the first device, via the wireless peer-to-peer direct connection between the first device and the second device and without utilizing any server, the first version of the content and a command to render the first version of the content at the second device, wherein the command causes the second device to display the first version of content at the second device according to one or more device settings included in the command.

9. The one or more computer-readable media of claim 8, wherein the one or more device settings includes clearing a cache on the second device.

10. The one or more computer-readable media of claim 8, wherein the one or more device settings includes clearing cookies on the second device.

11. The one or more computer-readable media of claim 8, wherein the one or more device settings includes a particular screen orientation.

12. The one or more computer-readable media of claim 8, wherein the wireless peer-to-peer direct connection comprises a WiFi or cellular network.

13. The one or more computer-readable media of claim 8, wherein the content comprises at least one of an image, video, print media, web page, web site, visual asset, and visual content.

14. The one or more computer-readable media of claim 8, further comprising:
establishing a wireless peer-to-peer direct connection between the first device and a third device without utilizing any server to establish the wireless peer-to-peer direct connection;
identifying, from the third device via the wireless peer-to-peer direct connection, device information of the third device, wherein the device information for the third device includes a display size and a resolution of the third device;
based on dimensions of the content and the display size and the resolution of the third device, modifying the content to generate a second version of the content that is customized for the dimensions of the content, and the display size and the resolution identified for the third device; and
transmitting to the third device, via the wireless peer-to-peer direct connection between the first device and the third device and without utilizing any server, the second version of the content and a command to render the second version of the content at the third device, wherein the command causes the third device to display the second version of content at the third device according to one or more device settings included in the command.

15. A method for displaying content, the method comprising:
identifying a content displayed at a first device;
establishing a wireless peer-to-peer direct connection between the first device, a second device, and a third device without utilizing any server to establish the wireless peer-to-peer direct connection;
customizing the content, at the first device, to be specific to each of the second device and the third device, wherein the customizing comprises:
identifying, from the second device via the wireless peer-to-peer direct connection, device information of the second device, wherein the device information for the second device includes a display size and a resolution of the second device;
identifying, from the third device via the wireless peer-to-peer direct connection, device information for the third device, wherein the device information for the third device includes a display size and a resolution of the third device, wherein the display size and resolution of the third device are different from the display size and resolution of the second device;
communicating the device information of each of the second and third devices to the first device via the wireless peer-to-peer direct connection;
identifying, at the first device, a second version of the content corresponding to the display size and the resolution for the second device; and
identifying, at the first device, a third version of the content corresponding to the display size and the resolution for the third device;
transmitting to the second device, via the wireless peer-to-peer direct connection between the first device and the second device and without utilizing any server, the second version of the content and a command to render the second version of the content at the second device, wherein the command causes the second device to display the second version of content at the second device; and
transmitting to the third device, via the wireless peer-to-peer direct connection between the first device and the third device and without utilizing any server, the third version of the content and a command to render the third version of the content at the third device, wherein the command causes the third device to display the third version of content at the third device.

16. The method of claim 15, wherein the content comprises at least one of an image, video, print media, web page, web site, visual asset, and visual content.

17. The method of claim 15, wherein the command causes the second device to display the second version of content at the second device according to one or more device settings included in the command.

18. The method of claim 17, wherein the one or more device settings include clearing a cache and cookies on the second device.

19. The method of claim 17, wherein the one or more device settings include achieving a particular screen orientation.

20. The method of claim 15, wherein the second device and the third device differ from each other in at least one of hardware, firmware, software, operating system, platform, browser, and content viewing applications.
